(19) United States
(12) Patent Application Publication
(10) Pub. No.: US 2016/0140571 A1
(43) Pub. Date: May 19, 2016

(54) SYSTEM AND METHOD FOR REMOTELY ASSESSING THE STATUS OF MOVABLE / NON- MOVABLE ASSET

(71) Applicants: Sara Parrish, Placentia, CA (US); Jim Parrish, Placentia, CA (US)

(72) Inventors: Sara Parrish, Placentia, CA (US); Jim Parrish, Placentia, CA (US)

(21) Appl. No.: 14/926,887

(22) Filed: Oct. 29, 2015

Related U.S. Application Data
(60) Provisional application No. 62/079,755, filed on Nov. 14, 2014.

(51) Int. Cl. G06Q 30/00

(52) U.S. Cl. CPC G06Q 30/018

(57) ABSTRACT

The present invention relates to a system and method for remotely accessing the status of a movable/non-movable asset within a network. The client initiates a verification request through a mobile interface and allows the customer to capture the movable/non-movable asset details for analyzing and generating the verification report of the movable/non-movable asset. Based on the verification report generated for the movable/non-movable asset, the client can assess the status of the movable/non-movable asset.

### FIELD OF THE INVENTION

This application claims priority to U.S. Provisional Patent Application No. 62/079,755, filed in the United States Patent and Trademark Office on Nov. 14, 2014. The specification of the above referenced patent application is incorporated herein by reference in its entirety. The present invention generally relates to remotely assessing the status of a movable/non-movable asset and more particularly relates to remotely assessing the status of movable/non-movable asset by capturing and comparing the information related to the asset remotely through a mobile device and further analyzing the captured information to generate a verification report for determining the status of the movable/non-movable asset.

### BACKGROUND OF THE INVENTION

Services like craigslist and eBay e-commerce web sites are useful for online product marketing. However, a user often has to take the risk of believing the information posted by a seller without any additional vetting process. As users have fallen victim to scams where dealers claim to have fully functional vehicles/products but in actuality the dealers can sell damaged vehicles/products. The present invention enables customer or buyers to overcome this issue by electronically requesting the aid of an individual who can verify the location and condition of the posted vehicle/product via a smart phone or tablet. In addition to allowing users to prevent scams, the present invention can be used by fleet managers to verify the location and condition of company vehicles/products online. The present invention could be used by dealerships, or many other individuals that would benefit from remotely verifying details about a movable/non-movable asset within the network.

### SUMMARY OF THE INVENTION

The present invention relates to a system and method for remotely assessing the status of a movable/non-movable asset through a mobile device, wherein the system comprises of a client application installed on the mobile device, a server, and the system is configured to receive a verification request from one or more clients to verify the movable/non-movable asset through the mobile device. Further, the system is configured to display the instruction received from the server to capture said movable/non-movable related information as required by the system and to confirm that the captured information is in accordance with the expected sample format stored on the server. Further, the system is configured to analyze the captured information after confirming that the captured information is in accordance with the expected sample format on the server and to generate a verification report based on the analysis performed for the captured information. Further, the system is configured to display the generated verification report on a web-based interface associated with the server and assess the status of said movable/non-movable asset through said mobile device based on the verification report generated for said movable/non-movable asset.

### BRIEF DESCRIPTION OF DRAWINGS

FIG. 1 illustrates a working overview of the system 100 used to remotely assess the status of a movable/non-movable asset through a mobile device.

FIG. 2 illustrates a flow-chart 200 that explains the process of remotely assessing the status of the movable/non-movable asset through the mobile device.

FIG. 3 illustrates a system overview 300 of components used to implement the method for remotely assessing the status of the movable/non-movable asset.

FIG. 4 illustrates an exemplary login screen-shot.

FIG. 5 illustrates an exemplary screen-shot for accepting the customer related information for requesting verification.

FIG. 6 illustrates an exemplary screen-shot for tracking the verification status

FIG. 7 illustrates an exemplary screen-shot depicting the verification report

### FIGURE DESCRIPTION

100—A working overview of the system

101—A network within which the system works

102—A server for receiving and analyzing the status of the movable/non-movable asset

103—A client application installed on the mobile device

104—A subscribed user availing the service through the server

105—A verification report generated for the movable/non-movable asset

200—A flow-chart explaining the process of verifying the status of movable/non-movable asset

300—A System overview of components

301—An Application module

302—A Subscription module

303—An Information Capturing module

304—A Comparison module

305—An Analyzing module

306—A Report Generation module

307—A Display module

308—A Controlling module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, the term mobile device refers to a device on which the client application 103 can be installed to send a verification request and to view the verification report for assessing the status of the movable/non-movable asset(s) within the network 101. For example, the mobile device includes but not limited to a smart phone, a laptop, an ipad, a tablet, a personal computer, or the like.

In an embodiment, the client application 103 is configured with a mobile interface for accepting the customer related information, for tracking/managing the verification status, and/or depicting the verification report.

The terms subscribed user and customer are used interchangeably throughout the document. In an embodiment, the customer is in need of verifying the movable/non-movable asset(s) within the network 101 and avails the service of a client or an agent to get the movable/non-movable asset verified through the system 100. For example, a customer in need of verifying of his/her vehicle insurance avails the verification service from an insurance company (referred to as an agent in the following document). Further, the terms client and agent are used interchangeably throughout the document.

In an embodiment, the term customer device refers to a device through which the movable/non-movable asset related information can be captured within the network 101 for verifying the asset based on the captured details. For example, the customer device includes but not limited to a smart phone, a laptop, an ipad, a tablet, a personal computer, or the like.

In an embodiment, the term movable asset refers to tangible assets that are characterized by mobility, such as a vehicle, a computer, a painting, jewelry, or the like.

In an embodiment, the term non-movable asset refers to the assets that are characterized by immobility, such as a land property, a plant and equipment, a factory, a house, or the like.

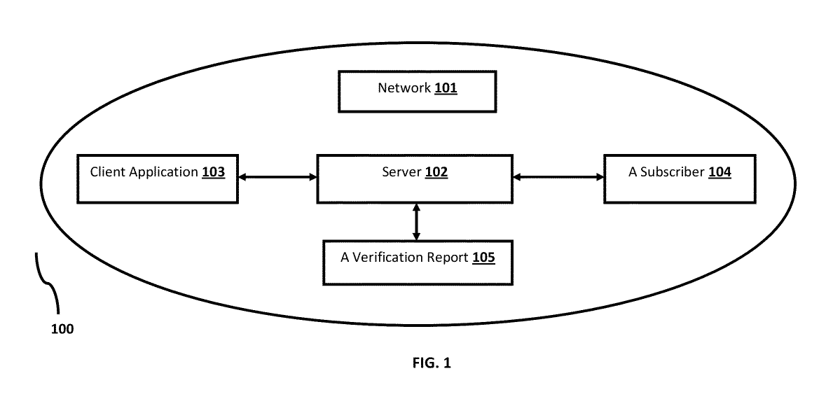

Referring to FIG. 1 illustrates a working overview of the system 100 used to remotely assess the status of a movable/non-movable asset through a mobile device. In an embodiment, the client application 103 installed on the mobile device allows one or more clients, also referred to as an agent, to submit a verification request to the server 102 within the network 101. Further, the client application 103 allows the client to specify the customer related information such as the customer name, email address, contact number, and other relevant details through the client application 103. Further, as the verification request is submitted to the server 102, the server 102 sends an invitation to the customer by email and/or by text message to download the client application 103 on the customer's device.

In an embodiment, as the customer installs the client application 103 on the customer's device, the server 102 is configured to guide the customer by detailing the entire verification process in a step-by-step manner through the mobile interface. Further, based on the step-by-step process illustrated by the server 102, the customer can continue to capture the necessary information for assessing the movable/non-movable asset within the network 101.

In an embodiment, the server 102 is configured to complete the verification process for the information captured and shared by the customer, and the client will be notified about the verification report through the client application 103 installed on the client's device.

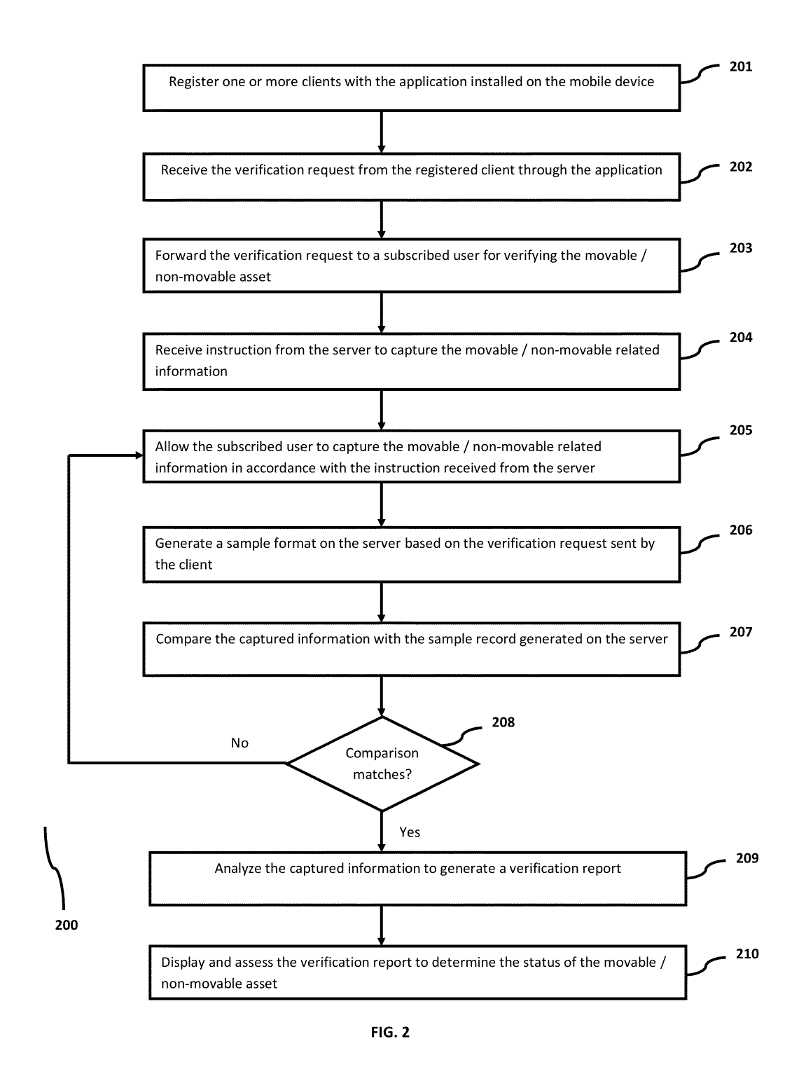

Referring to FIG. 2 illustrates a flow-chart 200 that explains the process of remotely assessing the status of the movable/non-movable asset through the mobile device. Initially, at step 201, the method 200 allows the client(s) to register with the application 103 installed on the mobile device. At step 202, as the client(s) register with the application 103, the method 200 allows the client(s) to send a verification request to remotely assess the status of the movable/non-movable asset(s) within the network 101. At step 203, the method 200 forwards the verification request to a server 102, which then identifies the customer device within the network 101. Upon identifying the customer device, the server 102 forwards the verification request to the intended customer. In an embodiment, as the customer device receives the verification request, the server 102 instructs the customer to install the client application 103 on the customer device. Upon successfully installing the client application 103 on the customer device, at step 204, the method 200 illustrates a step-by-step instruction for capturing the movable/non-movable asset details through the customer device for verifying the status of the asset. At step 205, the method 200 allows the customer to capture the details of the movable/non-movable asset in accordance with the instruction provided by the server 102. For example, the instruction for capturing the automobile vehicle includes but not limited, the angle at which the vehicle needs to be covered, the components of the vehicle that needs to be captured, the working condition details of the vehicle to be captured, the mileage of the vehicle to be captured, or the like that can be used for determining the vehicle condition and status remotely. At step 206, the server 102 is configured to generate a sample format of the movable/non-movable asset based on the verification request sent by the client(s). For example, if the verification request is to determine the working condition of the automobile vehicle then the server 102 is configured to generate a sample format of the automobile vehicle positioned at a specific angle that covers the important components of the vehicle, which directly or in-directly contributes to the condition of the automobile vehicle. Further, at step 207, the server 102 is configured to compare the captured information with the sample format generated by the server 102. Further, at step 208, the method 200 determines if the captured information matches with the sample format generated by the server 102. If the method 200 determines that there is a close match between the captured information and the sample format then at step 209, the method 200 instructs the server 102 to analyze the captured information for generating the verification report. Otherwise, the method 200 instructs the customer to capture the information of the movable/non-movable asset(s), which can be closely associated with the sample format. Further, at step 210, the method 200 instructs the server 102 to display the verification report on the mobile device of the client(s) who sent the verification request. Based on the verification report displayed on the mobile device, the client can assess the status of the movable/non-movable asset.

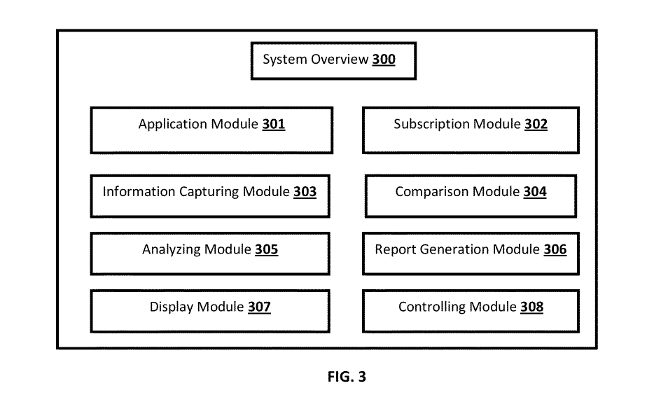

Referring to FIG. 3 illustrates a system overview 300 of components used to implement the method for remotely assessing the status of the movable/non-movable asset, wherein the system comprises of the following components: an Application module 301, a Subscription module 302, an Information Capturing module 303, a Comparison module 304, an Analyzing module 305, a Report Generation module 306, a Display module 307, and a Controlling module 308. In an embodiment, the Application module 301 is configured to install the client application 103 on the mobile device, wherein the client application 103 supports a mobile interface for sending a verification request from the client(s) within the network 101. In an embodiment, the Subscription module 302 is configured to subscribe the client user for availing the system service for remotely assessing the status of the movable/non-movable asset. In an embodiment, the Information Capturing module 303 is configured to capture the information of the movable/non-movable asset(s) that can be used for analyzing and generating a verification report. In an embodiment, the Comparison module 304 is configured to compare the captured information with the sample format that is generated by the system 100 based on the verification request sent by the client(s). The captured information that is closely associated with the sample format will be considered for analyzing and generating the verification report. Otherwise, the system 100 prompts the subscribed user/customer to capture the information until the captured information is in accordance with the sample format. In an embodiment, the Analyzing module 305 is configured to analyze the captured information for generating the verification report. In an embodiment, the Report Generation module 306 is configured to generate the verification report based on the analysis performed for the captured information. In an embodiment, the Display module 307 is configured to display the verification report generated by the system 100. In an embodiment, the Controlling module 308 is configured to transfer data or information across various modules supported in the system 100.

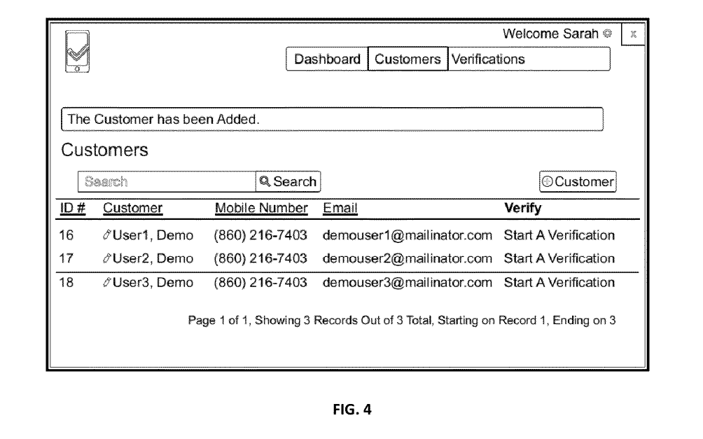

Referring to FIG. 4 illustrates an exemplary login screen-shot. As depicted in the figure, the login screen-shot allows the client or an agent to create a verification request through a mobile interface for assessing the status of the movable/non-movable asset(s). Further, the screen provides an option to manage the pending verification request(s) created by one or more client(s), and allows the client or an agent to download/generate the verification report.

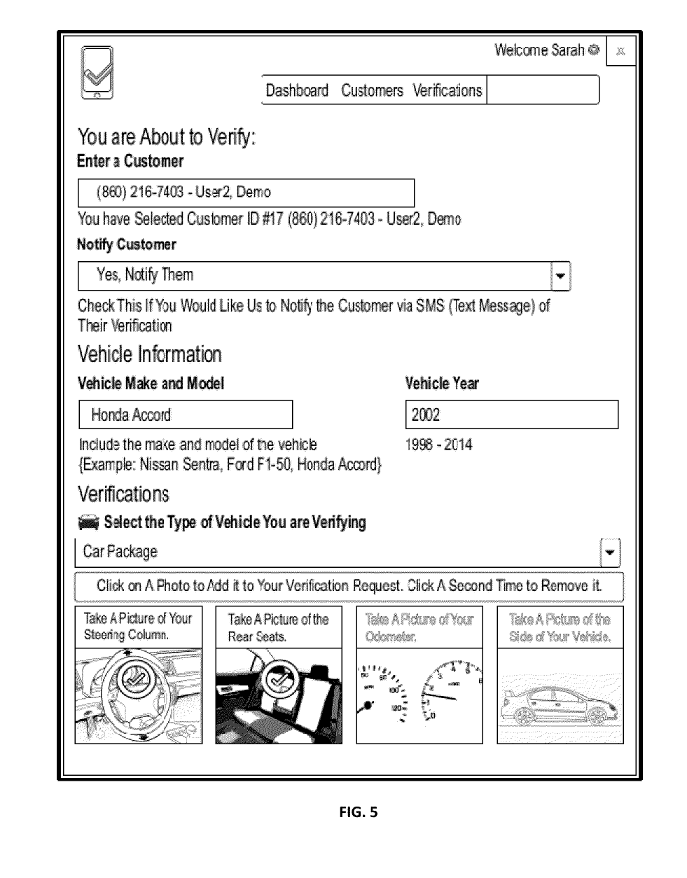

Referring to FIG. 5 illustrates an exemplary screen-shot for accepting the customer related information for requesting verification. As depicted in the figure, the mobile interface allows the client to enter the customer related information for initiating the verification request. In an embodiment, the customer upon receiving the verification request can continue to capture the movable/non-movable asset related details for verifying the status of the asset.

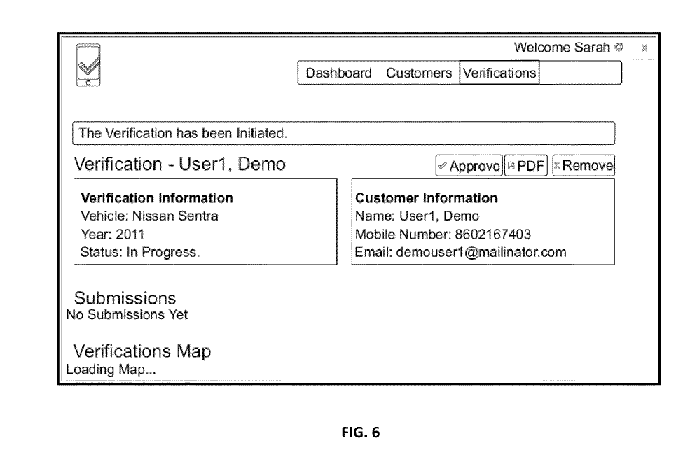

Referring to FIG. 6 illustrates an exemplary screen-shot for tracking the verification status. As depicted in the figure, the mobile interface displays the current status of the verification request initiated by the client(s).

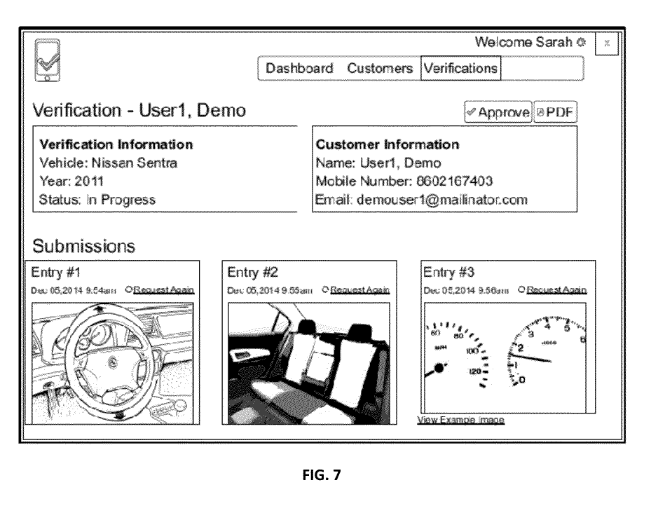

Referring to FIG. 7 illustrates an exemplary screen-shot depicting the verification report. In an embodiment, as the verification of the movable/non-movable asset is completed, a report is generated at the server 102 and the server 102 displays the generated report on the mobile interface of the client application 103. Based on the generated report, the client can assess the status of the movable/non-movable asset that is verified through the system 100. In an embodiment, the system 100 can be configured to generate a reporting metrics to track completed verifications, customer progress in pending verifications along with an overall usage and billing information for availing the service.

1. A system implementing a method for remotely assessing the status of a movable/non-movable asset through a mobile device, wherein said system comprises of a client application installed on said mobile device, a server, and said system is configured to:
receive a verification request from at least one client to verify said movable/non-movable asset through said mobile device;
display the instruction received from said server to capture said movable/non-movable related information as required by the system;
confirm that the captured information is in accordance with the expected sample format stored on said server;
analyze the captured information after confirming that the captured information is in accordance with the expected sample format on said server;
generate a verification report based on the analysis performed for the captured information;
display the generated verification report on a web-based interface associated with said server; and
assess the status of said movable/non-movable asset through said mobile device based on the verification report generated for said movable/non-movable asset.

2. The system as claimed in claim 1, wherein capturing information related to said movable/non-movable asset includes capturing information such as the angle in which the movable/non-movable asset needs to be captured, the date and time during which the movable/non-movable asset needs to be captured, the geolocation where the movable/non-movable asset needs to be captured for remotely assessing the movable/non-movable asset through said system.

3. The system as claimed in claim 1, wherein the movable asset comprises of tangible assets that are characterized by the mobility, such as a vehicle, a computer, a painting, jewelry, or the like.

4. The system as claimed in claim 1, wherein the non-movable asset comprises of assets that are characterized by immobility, such as a land property, a plant and equipment, a factory, a house, or the like.

5. The system as claimed in claim 1, wherein the system is configured to subscribe at least one client with the system by accepting the personal information such as the user's name, Email, Phone number, movable/non-movable asset information, or the like through said web-based interface.

6. The system as claimed in claim 1, wherein the system is configured to provide the instruction in a stepwise manner to said at least one subscribed user to capture said movable/non-movable related information as required by the system.

7. The system as claimed in claim 5, wherein the system is configured to receive said movable/non-movable related information from said at least one subscribed user that is captured based on the instruction provided to said at least one subscribed user for assessing the status of said movable/non-movable asset by said system.

8. The system as claimed in claim 1, wherein the system is configured to generate the sample format, which can be represented in the form of an image, a recorded working condition of said movable/non-movable asset during a specified period of time, a boundary enclosing the movable/non-movable asset, which can be determined based on said verification request received from said at least one client.

9. The system as claimed in claim 1, wherein the system is configured to compare the captured information with the sample format generated by said system to determine if the captured information is in accordance with required format.

10. A method implemented for remotely assessing the status of a movable/non-movable asset through a mobile device, wherein said method comprises of:
receiving a verification request from at least one client to verify said movable/non-movable asset through said mobile device;
displaying the instruction received from a server to capture said movable/non-movable related information as required by the system;
confirming that the captured information is in accordance with the expected sample format;
analyzing the captured information after confirming that the captured information is in accordance with the expected sample format on said server;
generating a verification report based on the analysis performed for the captured information;
displaying the generated verification report on a web-based interface associated with said server; and
assessing the status of said movable/non-movable asset through said mobile device based on the verification report generated for said movable/non-movable asset.

11. The method as claimed in claim 10, wherein capturing information related to said movable/non-movable asset includes capturing information such as the angle in which the movable/non-movable asset needs to be captured, the date and time during which the movable/non-movable asset needs to be captured, the geolocation where the movable/non-movable asset needs to be captured for remotely assessing the movable/non-movable asset through said system.

12. The method as claimed in claim 10, wherein the movable asset comprises of tangible assets that are characterized by the mobility, such as a vehicle, a computer, a painting, jewelry, or the like.

13. The method as claimed in claim 10, wherein the non-movable asset comprises of assets that are characterized by immobility, such as a land property, a plant and equipment, a factory, a house, or the like.

14. The method as claimed in claim 10, wherein the method subscribes said at least one client with the system by accepting the personal information such as the user's name, Email, Phone number, movable/non-movable asset information, or the like through said web-based interface.

15. The method as claimed in claim 10, wherein the method provides instruction in a stepwise manner to said at least one subscribed user to capture said movable/non-movable related information as required by the system.

16. The method as claimed in claim 15, wherein the method receives said movable/non-movable related information from said at least one subscribed user that is captured based on the instruction provided to said at least one subscribed user for assessing the status of said movable/non-movable asset by said system.

17. The method as claimed in claim 10, wherein the method generates the sample format, which can be represented in the form of an image, a recorded working condition of said movable/non-movable asset during a specified period of time, a boundary enclosing the movable/non-movable asset, which can be determined based on said verification request received from said at least one client.

18. The method as claimed in claim 10, wherein the method compares the captured information with the sample format generated by said system to determine if the captured information is in accordance with required format.
